(19) United States
(12) Patent Application Publication
(10) Pub. No.: US 2002/0030112 A1
(43) Pub. Date: Mar. 14, 2002

(54) Human readable barcode label

(75) Inventor: Graeme Schreiber, Renfrewshire (GB)

Correspondence Address: Douglas R. Millett, IBM Corp, IP Law, Department L2PA/014-2, 5600 Cottle Road, San Jose, CA, 95193, US

(73) Assignee: International Business Machines Corporation

(21) Appl. No.: 09/946,746

(22) Filed: Sep. 4, 2001

(30) Foreign Application Priority Data
Sep. 9, 2000 (GB) GB 0022127.5

(51) Int. Cl. G06K 19/06

(52) U.S. Cl. 235/494

(57) ABSTRACT

A barcode encodes information in a digital format readable by an optical instrument. Conventionally, barcodes comprise a machine readable portion and a human readable portion, the portions being physically separate. The invention is the use of an ink for the machine readable portion which is visible to the barcode reader instrument when exposed to ultra-violet light or to ultra-violet light. The human readable information may correspond to the machine readable information or it may differ. The respective absorption spectra of the machine readable portion and the human readable portion have no significant overlap and the machine readable portion has no significant absorption in the visible region of the spectrum.

### TECHNICAL FIELD OF THE INVENTION

The present invention relates to barcode labels and more particularly to barcodes containing a human readable element.

### BACKGROUND OF THE INVENTION

Barcodes are normally used to identify products in a unique manner. A barcode is a sequence of black and white vertical stripes which correspond to a digital code providing information about products. A barcode reader can detect the sequence and decode the relevant information.

Conventionally, if it is desired to provide a machine readable barcode that is also human readable, then this is done by either repeating the information in an area separate from the barcode or by using a lenticular screen so as to provide two different images when viewed from different directions.

Japanese Patent 10105974 discloses the use of low density barcode symbols and high density barcode symbols formed as through holes in a radial pattern on the innermost circumference of an optical disk. The high density barcode symbols may form human readable text or a logotype.

Great Britain Patent Application 9927381.5 discloses a barcode which has characteristics of the barcode, such as the darkness of the dark vertical stripes or the lightness of the light vertical stripes, modified in a manner such that the dark and light stripes stay within the thresholds of the automated reading equipment, but that the human eye sees a pattern of image and/or text in the differing dark and light lines. The use of colours other than black and white is disclosed. The barcodes are printed using a conventional computer printer and conventional inks and the entirety of the content, that is both the human readable and machine readable portions, of the barcode is viewable in normal daylight. The human readable portion of the barcode label can be easily confused by the presence of the machine readable one or vice versa.

U.S. Pat. No. 5,499,116 discloses the use of hologram structures to contain human viewable information as well as machine readable indicia. The human viewable information may be a company logo or a company name and the machine readable indicia may be a barcode. The human readable indicia is readable in normal light. The machine readable indicia is only readable when illuminated with playback illumination that emulates the original reference beam as defined by well-known grating equation.

Polarisation sensitive inks that reflect right-hand or left-hand circularly polarised light are known and can be used to provide a barcode in which human readable information is superimposed over the machine readable information. However, special viewing conditions are required to view the human readable information.

So it would be desirable to provide a barcode which is machine readable together with human readable information in the same physical area, without degrading the readability of either the human readable information or the machine readable information and without requiring special conditions for viewing the human readable information.

### SUMMARY OF THE INVENTION

Accordingly, the present invention provides a barcode for encoding information in a digital format readable by an optical instrument, the barcode comprising a machine readable portion visible to the optical instrument and not visible to a human observer and a human readable portion visible to a human observer and not visible to an optical instrument.

The machine readable portion of the barcode is not visible to the human observer and so does not affect the legibility of the human readable portion of the information. This allows the human readable information to be physically placed at the same location as the machine readable information, which is a particular advantage when space for labels on a product or its packaging is at a premium. The present invention is particularly advantageous for 2D barcodes using scanners that operate in the infra-red or ultra-violet parts of the spectrum.

In a first embodiment, the machine readable portion is visible to the optical instrument when exposed to infra-red light.

In a second embodiment, the machine readable portion is visible to the optical instrument when exposed to ultra-violet light.

In a preferred embodiment, the information contained within the human readable portion corresponds to the information stored in digital format in the machine readable portion.

Preferably, the respective absorption spectra of the machine readable portion and the human readable portion have no significant overlap and the machine readable portion has no significant absorption in the visible region of the spectrum. The human readable portion then has no effect on the readability of the machine readable portion and the machine readable portion is not visible to the human observer and so has no effect on legibility of the human readable portion.

The invention also provides a method of representing human readable information in a barcode having information encoded in a digital format readable by an optical instrument, the method comprising the steps of: providing a machine readable portion visible to the optical instrument and not visible to a human observer; and providing a human readable portion not visible to the optical instrument and visible to a human observer.

The invention further provides a barcode system comprising: an optical instrument capable of reading and decoding the information encoded in a digital format; and a barcode as described above.

The invention further provides a computer program for storing the barcode described above.

The invention further provides a computer program for creating the barcode described above.

### BRIEF DESCRIPTION OF PREFERRED EMBODIMENTS OF THE DRAWINGS

Embodiments of the invention will now be described, by way of example only, with reference to the accompanying drawings, in which:

FIG. 1 is a prior art barcode label having a machine readable portion and a human readable portion;

FIG. 2 shows the machine readable portion of a barcode according to the present invention viewed using a reader sensitive to other than visible light;

FIG. 3 shows the human readable portion of a barcode according to the present invention;

FIG. 4 shows a graph of the absorption spectra of inks used for printing the human readable portion and the machine readable portion of a barcode according to the present invention;

FIG. 5 shows a flow chart of the steps used in a method according to the present invention;

FIG. 6 shows a barcode system according to the present invention; and

FIG. 7 shows a computer program CDROM containing computer programs for storing a barcode according to the present invention and for creating a barcode according to the present invention.

### DETAILED DESCRIPTION OF PREFERRED EMBODIMENTS OF THE INVENTION

FIG. 1 shows a prior art barcode label 100 having a machine readable portion 102 and human readable portions 104, 106. The machine readable portion 102 is printed according to any one of many well-known and defined specifications and is readable by a conventional barcode reader. One-dimensional barcodes may be printed in Code 11, UPC-A, UPC-E, Industrial 2 of 5, Code 39, EAN-8, EAN-13, LOGMARS, Code 93, Plessey, Postnet, Code 128, Interleaved 2 of 5, MSI, Codabar, Standard 2 of 5, UCC/EAN 128 formats or others. Two-dimensional barcodes may be printed in stacked form as PDF417, Code 49, Codablock or Code 16K formats or in Matrix form as MaxiCode or Datamatrix formats or other formats may be used. In the example of FIG. 1, code EAN-13 is used.

The human readable portions 104, 106 consist of a human readable representation 106 of the barcode information together with other information 104 identifying the item with which the barcode label 100 is associated, but which is not reflected in the barcode information.

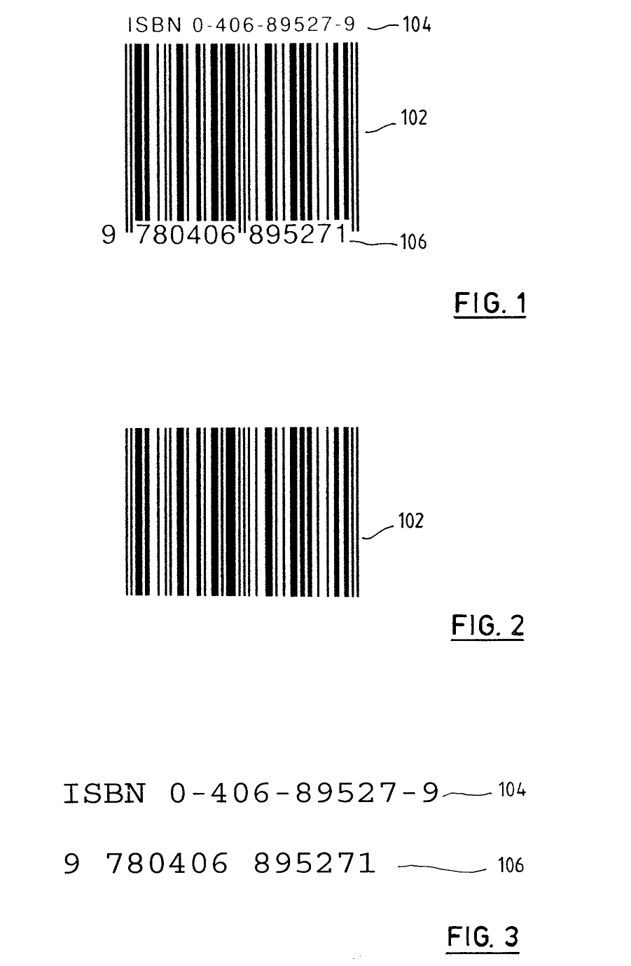

FIG. 2 shows the machine readable portion 102 of a barcode label 100 according to the present invention. The illustration of FIG. 2 shows the machine readable portion as it would be seen when viewed using a reader sensitive to light other than visible light, such as, for example, infra-red light having a wavelength of, for example, 900 nm, or ultra-violet light. The machine readable portion shown in FIG. 2 is not visible when illuminated and seen in light of wavelengths visible to a human. Conventional printing techniques can be used for printing the barcode, although the ink used needs to be of a type not visible to a human, but visible in infra-red or ultra-violet light.

FIG. 3 shows the human readable portion 104, 106 of the barcode label 100 according to the present invention. The illustration of FIG. 3 shows the human readable portion as it would be seen when viewed by the human observer. The human readable portion 104, 106 shown in FIG. 3 comprises two parts. The first part 106 is a human readable representation of the information contained within the machine readable barcode portion 102. The second part 104 is other human readable information, unrelated to the content of the machine readable barcode portion 102. In the example shown, the second part is the ISBN number of a book with which the barcode is associated. The second part may be textual information or it may be a logotype or a graphical image of any type. It may be single colour or multi-coloured. In embodiments of the present invention, the human readable information contained in the first part 106 only may be included, or the human readable information contained in the second part 104 only may be included or the human readable information contained in both the first part 106 and the second part 104 may be included.

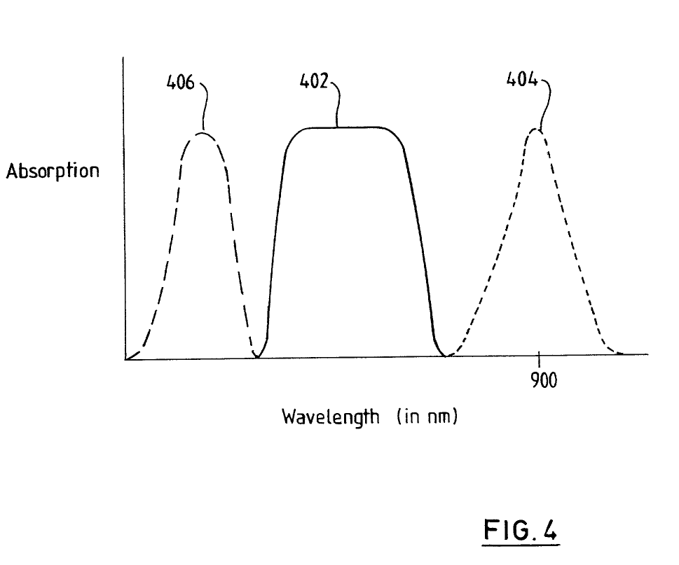

FIG. 4 shows a graph of the absorption spectra of inks suitable for printing the human readable portion and for printing the machine readable portions of a barcode according to the present invention. Line 402 shows the absorption spectra of an ink which absorbs visible light and so is seen by the human observer as black. Line 404 shows the absorption spectra of a first type of ink which is absorbent in the infra-red range of light wavelengths. Line 406 shows the absorption spectra of a second type of ink which is absorbent in the ultra-violet range of light wavelengths. As can be seen from the absorption spectra 402, 404, 406 of the machine readable portion and the human readable portion there is no significant overlap and the machine readable portion has no significant absorption in the visible region of the spectrum. Thus the machine readable portion is not visible to the human observer and the human readable portion has no effect on the operation of the machine readable portion.

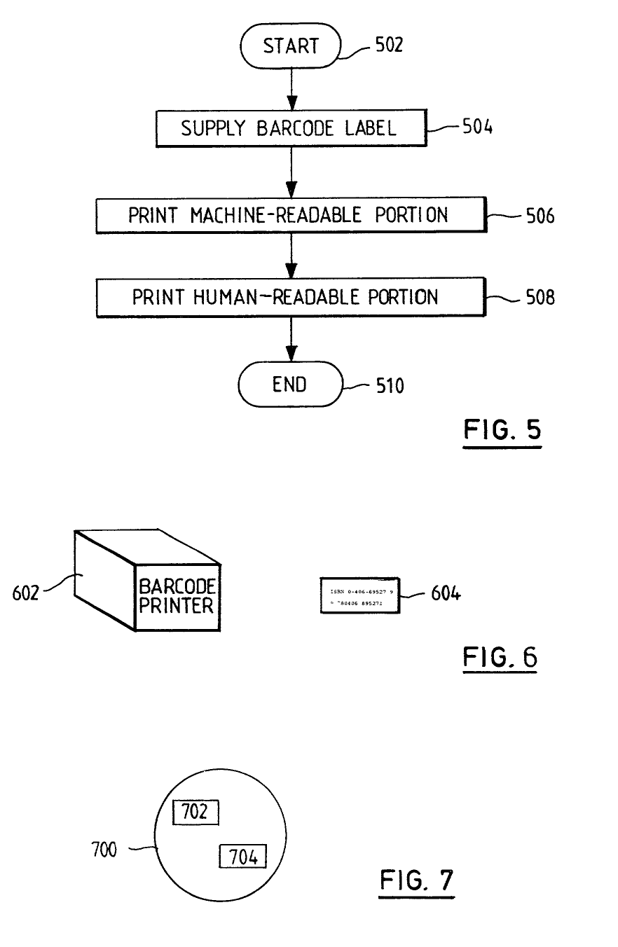

FIG. 5 shows a flow chart diagram of the steps of a method used to produce a barcode according to the present invention. The method starts at step 502. At step 504, a barcode label is supplied. At step 506, the machine readable portion visible to the optical instrument and not visible to a human observer is printed. At step 508, the human readable portion not visible to the optical instrument and visible to a human observer is printed. Steps 506 and 508 may be reversed in order or repeated as many times as is necessary. At step 510, the method ends.

FIG. 6 shows a barcode system of the present invention. At 602 is shown an barcode reader which is capable of reading and decoding the information encoded in a digital format and at 604 is shown a barcode label such as that shown in FIGS. 2 and 3.

FIG. 7 shows a computer program CDROM 700 containing computer programs 702 for storing a barcode according to the present invention and computer programs 704 for creating a barcode according to the present invention. The programs may be stored on media other than a CDROM, such as a diskette or may be downloaded over a computer network, such as, for example, the Internet World Wide Web.

While the preferred embodiments have been described here in detail, it will be clear to those skilled in the art that many variants are possible without departing from the spirit and scope of the present invention. In particular, the preferred embodiments have been described in terms of inks visible in the infra-red and ultra-violet spectra, whereas the present invention may also be advantageously applied to inks visible in other non human-visible spectra. Equally, the invention should not be seen as limited to the particular architectures and protocols described in the preferred embodiments, as those skilled in the art will readily see that the invention may advantageously be applied in systems having other architectures and protocols. In particular, the present invention may be used in order to assist in the prevention of counterfeiting. Simple copying of the bar code will not copy the entire content of the barcode as the infra-red or ultra-violet portion will not be copied.

What is claimed:

1. A barcode for encoding information in a digital format readable by an optical instrument, the barcode comprising a machine readable portion visible to the optical instrument and not visible to a human observer and a human readable portion visible to a human observer and not visible to the optical instrument.

2. A barcode as claimed in claim 1 wherein the machine readable portion is visible to the optical instrument when exposed to ultra-violet light.

3. A barcode as claimed in claim 1 wherein the machine readable portion is visible to the optical instrument when exposed to infra-red light.

4. A barcode as claimed in claim 1 wherein the information contained within the human readable portion corresponds to the information stored in digital format in the machine readable portion.

5. A barcode as claimed in claim 1 wherein the respective absorption spectra of the machine readable portion and the human readable portion have no significant overlap and the machine readable portion has no significant absorption in the visible region of the light spectrum.

6. A method of representing human readable information in a barcode having information encoded in a digital format readable by an optical instrument, the method comprising the steps of:
providing a machine readable portion visible to the optical instrument and not visible to a human observer; and
providing a human readable portion not visible to the optical instrument and visible to a human observer.

7. A method as claimed in claim 6 wherein the machine readable portion is visible to the optical instrument when exposed to ultra-violet light.

8. A method as claimed in claim 6 wherein the machine readable portion is visible to the optical instrument when exposed to infra-red light.

9. A method as claimed in claim 6 wherein the information contained within the human readable portion corresponds to the information stored in digital format in the machine readable portion.

10. A method as claimed in claim 6 wherein the respective absorption spectra of the machine readable portion and the human readable portion have no significant overlap and the machine readable portion has no significant absorption in the visible region of the light spectrum.

11. A barcode system comprising:
an optical instrument capable of reading and decoding information encoded in the barcode in a digital format; and
a barcode for encoding information in a digital format readable by an optical instrument, the barcode comprising a machine readable portion visible to the optical instrument and not visible to a human observer and a human readable portion visible to a human observer and not visible to the optical instrument.

12. A computer program for storing a barcode, the barcode being for encoding information in a digital format readable by an optical instrument, the barcode comprising a machine readable portion visible to the optical instrument and not visible to a human observer and a human readable portion visible to a human observer and not visible to the optical instrument.

13. A computer program for creating a barcode, the barcode being for encoding information in a digital format readable by an optical instrument, the barcode comprising a machine readable portion visible to the optical instrument and not visible to a human observer and a human readable portion visible to a human observer and not visible to the optical instrument.
